(19) United States
(12) Patent Application Publication
(10) Pub. No.: US 2004/0212737 A1
(43) Pub. Date: Oct. 28, 2004

(54) System simultaneously showing TV images and video camera images and its method

(75) Inventor: Chung-Fu Hsu, Taipei (TW)

Correspondence Address: BRUCE H. TROXELL, SUITE 1404, 5205 LEESBURG PIKE., FALLS CHURCH, VA, 22041, US

(73) Assignee: Thp Technology Co., Ltd.

(21) Appl. No.: 10/419,894

(22) Filed: Apr. 22, 2003

(51) Int. Cl. H04N 9/74

(52) U.S. Cl. 348/584

(57) ABSTRACT

The present invention discloses a system for simultaneously showing TV images and video camera images and method of the same, the system comprises: a TV interface device for receiving TV image signals; at least one video camera signal receiving device for capturing video camera image signals; at least one multiplexing circuit-switch device connected to the TV interface device and the video camera signal receiving device for receiving the TV image signals and the video camera image signals from the TV interface device and the video camera signal receiving device respectively, and further switching the TV image signals and the video camera image signals; an audio and video capturing chip device connected the multiplexing circuit-switch device to receive and process signals from thereon; and an interface circuit device connected the audio and video capturing chip device with an external display device, such as a computer screen. Via the method and the system of the present invention, TV image signals and video camera image signals are thus shown on a same display device at the same time for users' convenience.

### BACKGROUND OF THE INVENTION

1. Field of the Invention

The present invention generally relates to a system simultaneously showing TV images and video camera images and its method. By way of the present invention, the TV images and the video signals appear in a display device at the same moment, such as a computer display.

2. Description of the Prior Art

Recently, by way of the science developed, pc has been applied in many different categories, including browsing Internet, working and data processing. A s a matter of fact, adding a TV interface card to a PC or a notebook will make a PC or notebook become a recreation center. The center functions as a TV, which also plays programmed recording, home video edition, etc. Further, following the worse security in real world, the computerized monitoring system is broadly utilized as well.

Actually, a computer with TV interface card and a monitoring system are two split systems. The designer shall design two independent systems based on users' requests. As it can be seen, two different systems are inconvenient and should cost a lot.

The present invention discloses a system simultaneously showing TV images and video camera images and its method. That is, with the system and the method of the present invention, both TV images and video camera images are provided on a same display device, like a computer screen, at the same time. Therefore, users will be able to monitor these two signals together. As a result, the cost to install the system then decrease and the convenience highly increase.

### SUMMARY OF THE INVENTION

The main objective of the present invention is to offer a system simultaneously showing TV images and video camera images. The system comprises: a TV interface device for receiving TV image signals; at least one video camera signal receiving device for capturing video camera image signals; at least one multiplexing circuit-switch device connected the TV interface device and the video camera signal receiving device for receiving the TV image signals and the video camera image signals from the TV interface device and the video camera signal receiving device respectively, and further switching the TV image signals and the video camera image signals; an audio and video capturing chip device connected the multiplexing circuit-switch device to receive and process signals from thereon; and an interface circuit device connected the audio and video capturing chip device with an external display device, such as a computer screen. Via the method and the system of the present invention, TV image signals and video camera image signals are thus shown on a same display device at the same time so that it is convenient for users to operate.

The second objective of the present invention is to offer a method simultaneously showing TV images and video camera images. Steps of the method comprises: inputting individually the TV image signals and the Video camera image signals to their own assigning and processing module firstly; secondly the two individual assigning and processing modules engaging weighting processes with the TV image signals and the Video camera image signals; then inputting weighted processed image signal streams to a multiplexing module for composing an assembled image signal streams; continuously, inputting the assembled image signal streams to a vertical synchronizing detecting module for catching image signal streams; at last, outputting the captured image signal streams to a display device via interface circuits. The display device shall be as a computer screen. With the present invention, TV images and video camera images can be shown on the display device simultaneously for users' convenience.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a structural diagram of the present invention.

FIG. 2 is a flow chart diagram for the method of the present invention.

### DETAILED DESCRIPTION OF THE INVENTION

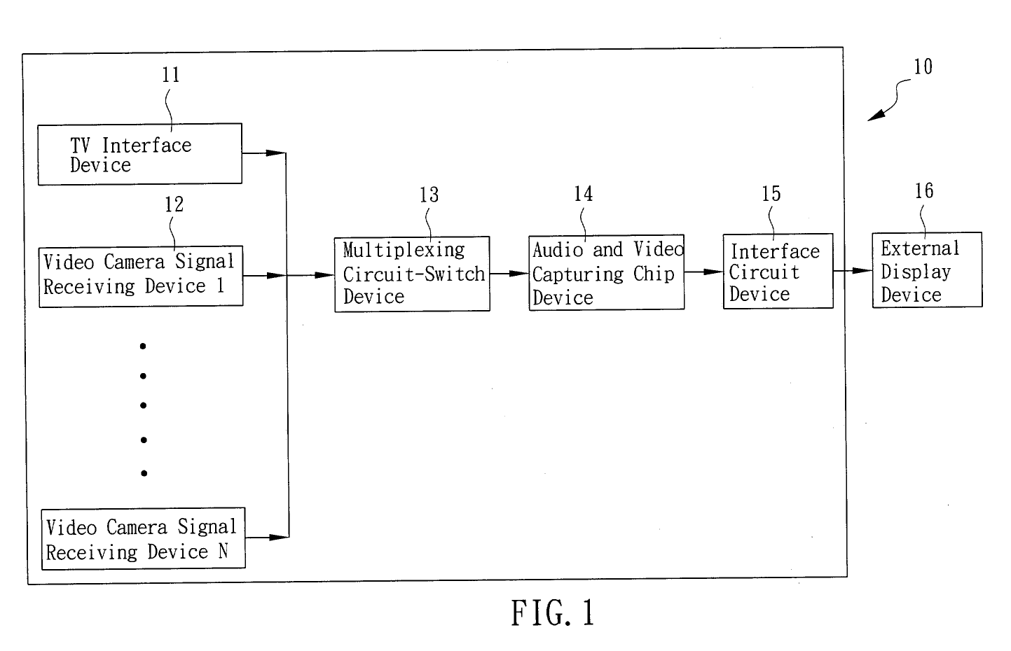

Referring to FIG. 1, which is a structural diagram of the present. As it can be seen, a system 10 of simultaneously showing TV images and video camera images comprises: a TV interface device 11 for receiving TV image signals; at least one video camera signal receiving device 12 for capturing video camera image signals; one multiplexing circuit-switch device 13 connected the TV interface device 11 and the video camera signal receiving device 12 for receiving the TV image signals and the video camera image signals from the TV interface device 11 and the video camera signal receiving device 12 respectively, and further switching the TV image signals and the video camera image signals; an audio and video capturing chip device 14 connected the multiplexing circuit-switch device 13 to receive and process signals from thereon; and an interface circuit device 15 connected the audio and video capturing chip device 14 with an external display device 16, such as a computer screen. Via the method and the system of the present invention, TV image signals and video camera image signals are thus shown on a same display device at the same time for users' convenience.

Referring to FIG. 1 again, the TV interface device 11 can receive TV image signals and transfer the received TV image signals to the multiplexing circuit-switch device 13, meanwhile, the video camera signal receiving device 12 is able to receive image signals from a video camera and then delivers the image signals to the multiplexing circuit-switch device 13. After the multiplexing circuit-switch device 13 connected to the TV interface device 11 and the video camera signal receiving device 12 receiving and processing the TV image signals and the video camera image signals from the TV interface device 11 and the video camera signal receiving device 12 respectively, the user or operator is able to switch between TV image signals and video camera image signals, followingly, the device 13 also outputting both signals to the audio and video capturing chip device 14. Continuously, after both signals being handled by the audio and video capturing chip device 14, the signals will be moved to the external display device 16 via the interface circuit device 15, and the interface circuit device 15 can be as a displaying card. The external display device 16 can be a PC screen. The tremendous feature of the present invention is that the system can be built up in a PC. Following the aforesaid, the system is capable of showing TV image signals and video camera image signals on a display device for operator's convenience.

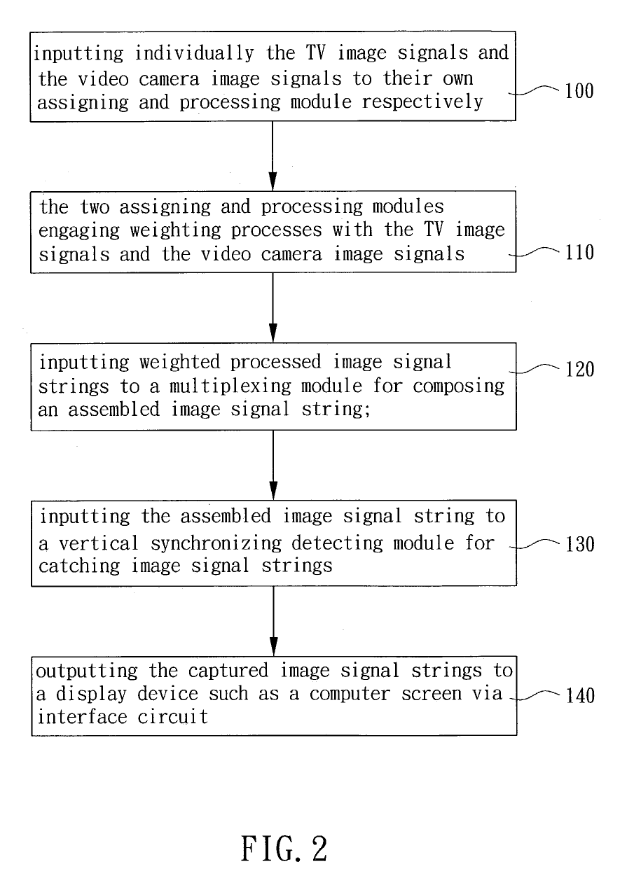

Referring to FIG. 2, which is a flow chart diagram for the method of the present invention. As shown, the steps of the method comprises:

step 100: inputting individually the TV image signals and the video camera image signals to their own assigning and processing module respectively;

step 110: the two assigning and processing modules engaging weighting processes with the TV image signals and the video camera image signals;

step 120: inputting weighted processed image signal streams to a multiplexing module for composing an assembled image signal string;

step 130: inputting the assembled image signal string to a vertical synchronizing detecting module for catching image signal streams;

step 140: outputting the captured image signal streams to a display device such as a computer screen via interface circuit.

As a conclusion, the present invention is full of the features with a simplified system and method. Thus, although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A system simultaneously showing TV images and video camera images comprising:
a TV interface device for receiving TV image signals;
at least one video camera signal receiving device for capturing video camera image signals;
at least one multiplexing circuit-switch device connected the TV interface device and the video camera signal receiving device for receiving the TV image signals and the video camera image signals from the TV interface device and the video camera signal receiving device respectively, and further switching the TV image signals and the video camera image signals;
an audio and video capturing chip device connected the multiplexing circuit-switch device for receiving and processing signals from thereon; and
an interface circuit device connected the audio and video capturing chip device with an external display device.

2. The system simultaneously showing TV images and video camera images as cited in claim 1, wherein the system can be built up in a PC.

3. The system simultaneously showing TV images and video camera images as cited in claim 1, wherein the TV interface device is a TV interface card.

4. The system simultaneously showing TV images and video camera images as cited in claim 1, wherein the video camera signal receiving device is a monitoring video camera.

5. The system simultaneously showing TV images and video camera images as cited in claim 1, wherein the interface circuit device is a displaying card.

6. The system simultaneously showing TV images and video camera images as cited in claim 1, wherein the external display device is a PC screen.

7. A method for simultaneously showing TV images and video camera images comprising the following steps:
(a): inputting individually the TV image signals and the Video camera image signals to their own assigning and processing module;
(b): each individual assigning and processing modules engaging weighting processes with the TV image signals and the video camera image signals respectively;
(c): inputting weighted processed image signal streams to a multiplexing module for composing an assembling image signal string;
(d): inputting the assembling image signal string to a vertical synchronizing detecting module for capturing image signal streams;
(e): outputting the captured image signal streams to an external display device via a interface circuit.

8. The method for simultaneously showing TV images and video camera images as cited in claim 7, wherein the interface circuit is a displaying card.

9. The method for simultaneously showing TV images and video camera images as cited in claim 7, wherein the external display device is a PC screen.
